(19) United States
(12) Patent Application Publication
(10) Pub. No.: US 2018/0013456 A1
(43) Pub. Date: Jan. 11, 2018

(54) DISTORTION COMPENSATION DEVICE AND DISTORTION COMPENSATION METHOD

(71) Applicant: FUJITSU LIMITED, Kawasaki-shi (JP)

(72) Inventors: Shunji Miyazaki, Kawasaki (JP); HIROYOSHI ISHIKAWA, Kawasaki (JP); Kazuo Nagatani, Yokohama (JP)

(73) Assignee: FUJITSU LIMITED, Kawasaki-shi (JP)

(21) Appl. No.: 15/622,694

(22) Filed: Jun. 14, 2017

(30) Foreign Application Priority Data
Jul. 11, 2016 (JP) 2016-137151

(51) Int. Cl. H04B 1/04; H04L 27/00

(52) U.S. Cl. CPC H04B 1/0475; H04L 27/0002; H04B 2001/0425

(57) ABSTRACT

A distortion compensation device includes a first table, a second table, a calculating unit, a first updating unit, and a second updating unit. The first table holds a coefficient of a nonlinear term included in a filtering coefficient associated with an address other than a prescribed address obtained from the input signal x(n). The second table holds a coefficient of a linear term related to the prescribed address. The calculating unit calculates, based on the output signal, each of the update amounts of the coefficient of the nonlinear term and the coefficient of the linear term. The first updating unit updates each of the coefficients in the first table based on the update amount of the coefficient of the nonlinear term. The second updating unit updates each of the coefficients of the second table based on the update amount of the coefficient of the linear term.

### CROSS-REFERENCE TO RELATED APPLICATION

This application is based upon and claims the benefit of priority of the prior Japanese Patent Application No. 2016-137151, filed on Jul. 11, 2016, the entire contents of which are incorporated herein by reference.

### FIELD

The embodiments discussed herein are directed to a distortion compensation device and a distortion compensation method.

### BACKGROUND

In a radio transmission device, a power amplifier that amplifies power of a transmission signal is provided. In the radio transmission device, in general, in order to increase the power efficiency of the power amplifier, the power amplifier is operated in the vicinity of the saturation region. However, when the power amplifier is operated in the vicinity of the saturation region, nonlinear distortion of the power amplifier is increased. Thus, to reduce the nonlinear distortion, in the radio transmission device, a distortion compensation device that compensates nonlinear distortion is provided.

There is a “digital predistortion technique (hereinafter, referred to as “DPD”)” as one of distortion compensation techniques used in a distortion compensation device. In the distortion compensation device that uses the DPD technique, a distortion compensation coefficient that has the inverse characteristics of the nonlinear distortion of the power amplifier is previously multiplied by the input signal that is input to the power amplifier. Consequently, the nonlinear distortion of the power amplifier is canceled out.

Furthermore, it is known that a phenomenon called memory effect occurs in the power amplifier with high power efficiency. The memory effect is a phenomenon in which an output with respect to an input to a power amplifier at a certain time is affected. As a technology that compensates the memory effect of the power amplifier, there is a known distortion compensation technique that uses the Volterra series. Furthermore, there is also a known distortion compensation technique that uses a generalized memory polynomial model that restricts the term of series in the Volterra series.

However, implementing the generalized memory polynomial model without change is not preferable from in terms of the amount of processing or the size of a circuit. Thus, from the viewpoint of reducing the amount of processing or the size of the circuit, there is a known distortion compensation technique that previously prepares a portion of the series included in the generalized memory polynomial model as a Look Up Table (LUT). In the distortion compensation technique that uses the LUT, an output of the power amplifier is fed back and each of the coefficients in the LUT is updated as needed based on the fed back signal.

However, in the distortion compensation technique that uses the LUT, offset may sometimes be accumulated in the coefficient in a process of updating the coefficients based on the feedback signal from the power amplifier. If the value of each of the coefficients becomes great due to accumulation of the offset, the value of each of the coefficients exceeds the value range allocated to each of the coefficients in the radio transmission device and thus it is difficult to properly correct the distortion.

To prevent this state, there is a known technology that estimates the average value of the coefficients in the LUT as an offset, that corrects the coefficients in the LUT by subtracting the estimated offset from each of the coefficients, and that reproduces, at the time of distortion compensation, the original coefficients by adding the estimated offset. Furthermore, there is also a known technology that reduces the offset to be accumulated by multiplying the prescribed forgetting coefficient α (0<α<1) when updating the value of each of the coefficients in the LUT. Related-art examples are described in Japanese Laid-open Patent Publication No. 2012-235316, Japanese Laid-open Patent Publication No. 2012-238966.

In a conventional process that suppresses the accumulation of the offset, the amount of processing is large. Thus, a reduction in the amount of processing is needed in the process performed in order to suppress the accumulation of the offset.

### SUMMARY

According to an aspect of an embodiment, a distortion compensation device that compensates, by filtering an input signal that is input to a power amplifier, distortion of an output signal that is output from the power amplifier, the distortion compensation device includes a first table, a second table, a calculating unit, a first updating unit, and a second updating unit. The first table holds, among a coefficient of a linear term and a coefficient of a nonlinear term that are included in filtering coefficients used for filtering of the input signal, the coefficient of the nonlinear term associated with an address other than a prescribed address obtained from the input signal. The second table holds the coefficient of the linear term related to the prescribed address. The calculating unit calculates, based on the output signal, each of an update amount of the coefficient of the nonlinear term and an update amount of the coefficient of the linear term. The first updating unit updates, based on the update amount of the coefficient of the nonlinear term, each of the coefficients in the first table. The second updating unit updates, based on the update amount of the coefficient of the linear term, each of the coefficients in the second table.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a distortion compensation device according to a first embodiment;

FIG. 2 is a schematic diagram illustrating an example of a first distortion compensation unit according to the first embodiment;

FIG. 3 is a schematic diagram illustrating an example of a LUT according to the first embodiment;

FIG. 4 is a schematic diagram illustrating an example of a second distortion compensation unit according to the first embodiment;

FIG. 5 is a schematic diagram illustrating an example of a coefficient updating unit according to the first embodiment;

FIG. 6 is a flowchart illustrating an example of a distortion compensation process according to the first embodiment;

FIG. 7 is a flowchart illustrating an example of a coefficient update process according to the first embodiment;

FIG. 8 is a schematic diagram illustrating an example of a coefficient updating unit according to a second embodiment;

FIG. 9 is a flowchart illustrating an example of a coefficient update process according to the second embodiment;

FIG. 10 is a schematic diagram illustrating an example of a coefficient updating unit according to a third embodiment;

FIG. 11 is a schematic diagram illustrating an example of an update amount limitation process;

FIG. 12 is a flowchart illustrating an example of a coefficient update process according to the third embodiment;

FIG. 13 is a schematic diagram illustrating an example of hardware of the distortion compensation device;

FIG. 14 is a schematic diagram illustrating another example of the update amount limitation process;

FIG. 15 is a block diagram illustrating an example of a distortion compensation device according to a comparative example;

FIG. 16 is a schematic diagram illustrating an example of a first distortion compensation unit according to the comparative example;

FIG. 17 is a schematic diagram illustrating an example of a LUT according to the comparative example;

FIG. 18 is a schematic diagram illustrating an example of a second distortion compensation unit according to the comparative example; and

FIG. 19 is a schematic diagram illustrating an example of a coefficient updating unit according to the comparative example.

### DESCRIPTION OF EMBODIMENTS

Preferred embodiments of the present invention will be explained with reference to accompanying drawings. Furthermore, the embodiments described below do not limit the disclosed technologies. Furthermore, each of the embodiments can be used in any appropriate combination as long as the processes do not conflict with each other.

Configuration of a Distortion Compensation Device 10a According to a Comparative Example

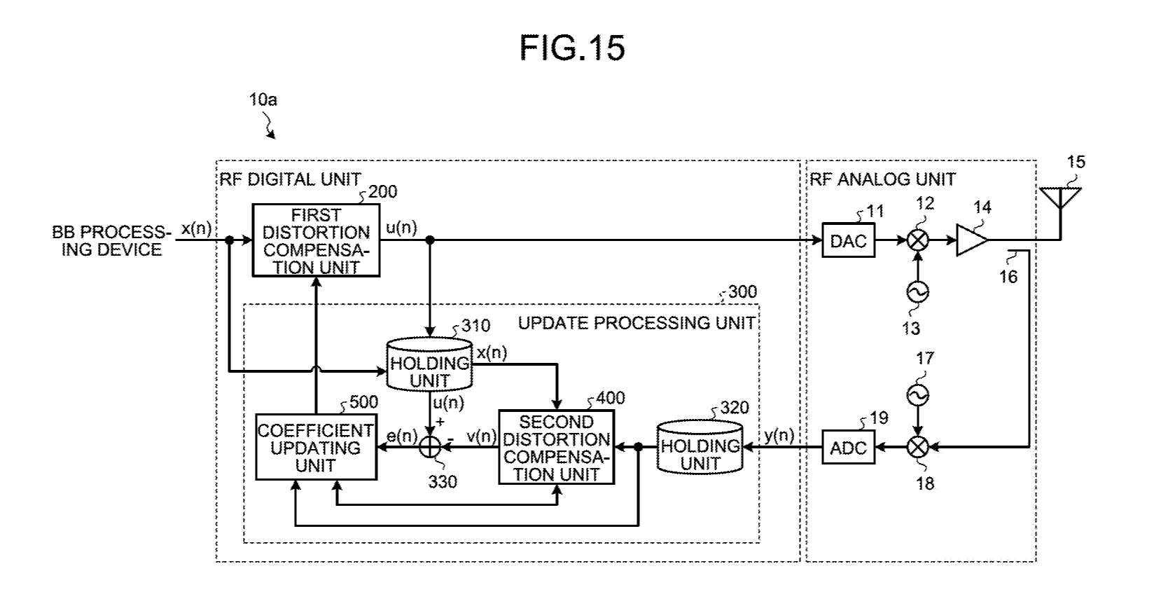

First, before a distortion compensation device 10 disclosed in the present application is described, the distortion compensation device 10a according to the comparative example will be described. FIG. 15 is a block diagram illustrating an example of the distortion compensation device 10a according to the comparative example. The distortion compensation device 10a according to the comparative example includes an RF digital unit, an RF analog unit, and an antenna 15. The RF analog unit includes a digital-to-analog converter (DAC) 11, a mixer 12, an oscillator 13, a power amplifier 14, a coupler 16, an oscillator 17, a mixer 18, and an analog-to-digital converter (ADC) 19. The RF digital unit includes a first distortion compensation unit 200 and an update processing unit 300. The update processing unit 300 includes a holding unit 310, a holding unit 320, a subtracter 330, a second distortion compensation unit 400, and a coefficient updating unit 500.

In the following, the basic configuration of an assumed distortion compensation device system will be described with reference to FIG. 15. In this application, as a specific example, a distortion compensation system that uses an indirect learning (IDL) method will be described. However, in also a distortion compensation system that uses a direct learning method, a description below is almost applied.

A base band signal (BB) processing device generates transmission data, performs signal processing, such as channel filtering, oversampling, or the like, and outputs transmission signal data x(n). Here, the transmission signal data x(n) indicates a complex symbol and n indicates the sample timing. Furthermore, in a description below, the transmission signal data x(n) may sometimes be referred to as an input signal x(n).

The first distortion compensation unit 200 performs, based on the distortion compensation coefficient, a distortion compensation process (hereinafter, sometimes referred to as DPD) on the transmission signal data x(n) that is output from the BB processing device. The result of the distortion compensation process performed by the first distortion compensation unit 200 is defined as u(n). The transmission signal data x(n) that is output from the BB processing device and the signal u(n) that is subjected to distortion compensation by the first distortion compensation unit 200 are held by the holding unit 310.

The signal u(n) in which distortion has been compensated by the first distortion compensation unit 200 is input to the RF analog unit and then converted to the signal that is actually transmitted from the antenna 15. Specifically, the signal u(n) that is the digital baseband signal and in which distortion has been compensated by the first distortion compensation unit 200 is converted to an analog signal by the DAC 11 and modulated by the mixer 12 and the oscillator 13. Then, the modulated signal is amplified to predetermined power by the power amplifier 14 and transmitted from the antenna 15. The output of the power amplifier 14 is fed back via the coupler 16 and demodulated by the oscillator 17 and the mixer 18. Then, the demodulated signal is converted to a digital signal by the ADC 19. The digital baseband signal converted by the ADC 19 is defined as y(n).

The signal y(n) that has been fed back from the RF analog unit is held in the holding unit 320. The second distortion compensation unit 400 performs, based on the transmission signal data x(n) held in the holding unit 310, the distortion compensation process on the signal y(n) that is held in the holding unit 320. The result of the distortion compensation process performed by the second distortion compensation unit 400 is defined as v(n).

The subtracter 330 calculates error data e(n)=u(n)−v(n) based on the signal u(n) that has been subjected to distortion compensation and that is held in the holding unit 310 and based on the signal v(n) in which distortion has been compensated by the first distortion compensation unit 200. The coefficient updating unit 500 updates the distortion compensation coefficients in the second distortion compensation unit 400 by using the error data e(n) and the signal y(n) that has been fed back from the RF analog unit. Then, by copying the distortion compensation coefficients in the second distortion compensation unit 400 to the first distortion compensation unit 200 at predetermined timing, the coefficient updating unit 500 updates the distortion compensation coefficients in the first distortion compensation unit 200.

Outline of the DPD

In general, a power amplifier exhibits an expected linear input/output characteristic in an area with low input power, whereas, the power amplifier exhibits a saturation characteristic in an area with high input power. If the power amplifier is operated in the area in which saturation characteristic is exhibited, the nonlinear distortion component included in the signal that is output from the power amplifier becomes large. If the power amplifier can be operated in the area in which input power is high, the overall power consumption of the power amplifier can be reduced and thus the power amplifier can be operated with high efficiency.

The DPD is a process of performing distortion compensation on the input signal that is input to the power amplifier such that all of the inputs/outputs become linear responses. Consequently, it is possible to satisfy both the improvement of linearity of the input/output characteristic and high efficient operation. The DPD is implemented, from the mathematical viewpoint, by allowing the nonlinear response function of the power amplifier to act as the inverse function thereof. In this application, it is assumed to use, in particular, an adaptive DPD that estimates, by feeding back a modulating signal output from the power amplifier, the coefficient of the inverse characteristic model, that copies the result thereof to the coefficient that is used for the DPD of the transmission signal, and that uses the copied coefficient. The DPD performed by using this method is called an IDL method.

DPD Model

From the mathematical viewpoint, the characteristic of the DPD is modeled as the function that indicates input/output responses of data. It is assumed that the target power amplifier has memory effect. In this case, as the model that is used to represent the effect of distortion compensation of the DPD, the Volterra series model is most commonly used. In this application, to simplify a description, a generalized memory polynomial model that is a further limited version of the term of the subject series will be described as a basic assumption. The signal u(n) that has been subjected to distortion compensation can be represented by, using the generalized memory polynomial model, for example, Equation (1) below:

$$u ( n ) = {\sum }_{k = 1}^{K} {\sum }_{j = 0}^{Q} {\sum }_{i = 0}^{Q} {h}_{i , j , k} {\vert x ( n - i ) \vert}^{k - 1} x ( n - j ) \qquad ( 1 )$$

In Equation (1), Q represents the maximum timing of a delay signal that receives the influence of the memory effect and K is the maximum order of the series.

LUT Method

[1] Nonlinear Function of the Model

Implementing the generalized memory polynomial model without modification leads an increase in the amount of processing or the size of a circuit because exponentiation operation is performed on the input data. To avoid this state, it is conceivable to hold the portion of the series included in the model as a LUT. If the generalized memory polynomial model indicated in Equation (1) described above is rewritten to a representation using a LUT, the signal u(n) that has been subjected to distortion compensation is represented by, for example, Equation (2) below.

$$u ( n ) = {\sum }_{j = 0}^{Q} ( {\sum }_{i = 0}^{Q} {L}_{i , j} ( \vert x ( n - i ) \vert ) ) x ( n - j ) \qquad ( 2 )$$

Consequently, the exponentiation operation performed on the series is deleted and the signal u(n) subjected to distortion compensation can be implemented by the sum of LUT coefficients L_{i,j}(|x(n−i)|) and a single multiplication operation (corresponding to linear filtering) per input signal.

Furthermore, the signal v(n) that has been subjected to distortion compensation performed on the feedback data output from the power amplifier can be represented by, for example, Equation (3) below.

$$v ( n ) = {\sum }_{j = 0}^{Q} ( {\sum }_{i = 0}^{Q} {L}_{i , j} ( \vert x ( n - i ) \vert ) ) y ( n - j ) \qquad ( 3 )$$

At this point, it is assumed that the LUT coefficient that is used for the distortion compensation performed on the feedback data is determined depend on |x(n−i)| instead of |y(n−i)|.

Furthermore, it is assumed that the association relationship between a power series and a LUT coefficient satisfies, for example, Equation (4) below.

$${L}_{i , j} ( \vert x ( n - i ) \vert ) = {\sum }_{k = 1}^{K} {h}_{i , j , k} {\vert x ( n - i ) \vert}^{k - 1} \qquad ( 4 )$$

However, if the LUT coefficient is once represented by L_{i,j}(|x(n−i)|), this is not restricted by information indicating that the subject LUT coefficient is originally represented by the power series on the right side of the equation. It is also conceivable that L_{i,j}(|x(n−i)|) only depends on |x(n−i)| and is associated with a certain nonlinear function.

[2] Constructing a LUT of a Nonlinear Function

Equation (2) or (3) above is the representation in which the series function is simply replaced with a general nonlinear function. In the LUT method, it is assumed that this nonlinear function is literally held as a LUT by using a prescribed buffer. Each of the addresses of the buffer memory is defined by associating the addresses from |x(n−i)| that is a continuous signal to a discrete index.

It is conceivable to use several methods for associating each of the addresses of the buffer memory with the signal. In this application, for specific explanation, a method of quantizing, at equal intervals in accordance with the prescribed buffer size, a value of the amplitude of a signal in the previously estimated range is used as the basic method. Furthermore, as another example, each of the addresses may also be determined based on the power value of the signal.

If the actual amplitude and the associated address are clarified in a distinguishable manner, a mapping function, such as iₐ=iₐ(|x(n−i)|), is used. However, it is assumed that |x(n−i)| itself represents the associated address unless misunderstanding occurs. Namely, it is assumed that L_{i,j}(|x(n−i)|) in the LUT means the element of the address that is associated with |x(n−i)|.

[3] Initialization of the LUT

As the initialization operation of the distortion compensation process, the coefficient in each of the LUTs is set such that u(n)=x(n) is satisfied.

L_{0,0}(|x(n)|)=1

L_{i,j}(|x(n)|)=0, where i≠0 or j≠0

First Distortion Compensation Unit 200

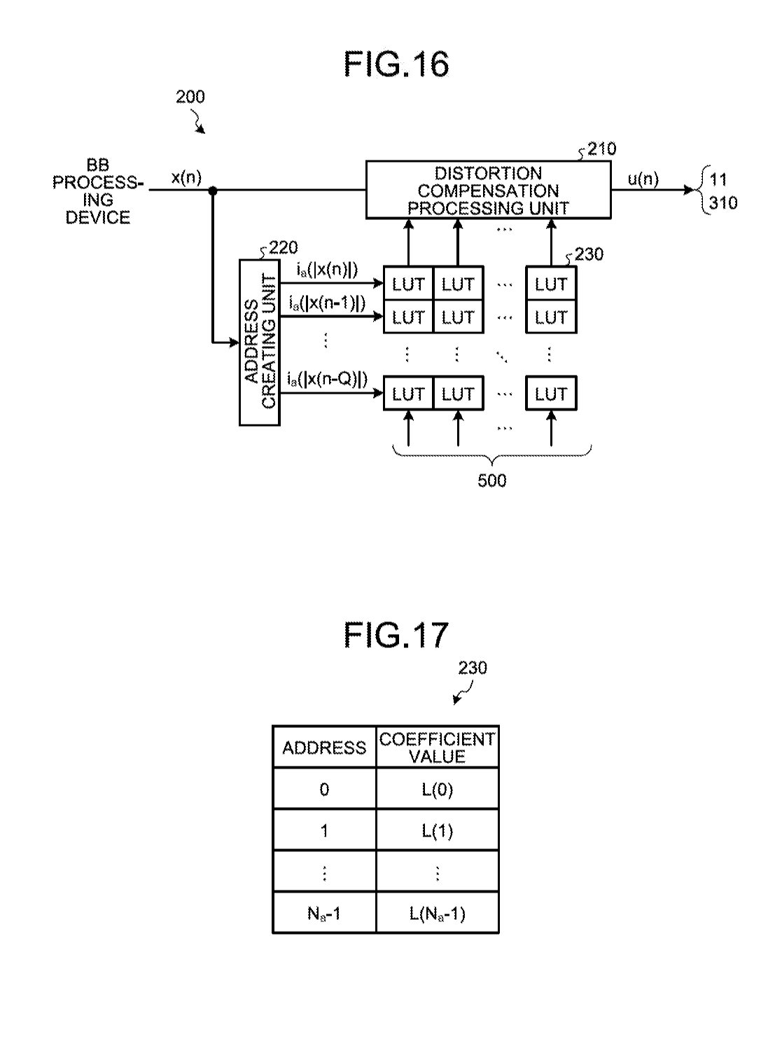

FIG. 16 is a schematic diagram illustrating an example of the first distortion compensation unit 200 according to the comparative example. The first distortion compensation unit 200 according to the comparative example includes, for example, as illustrated in FIG. 16, a distortion compensation processing unit 210, an address creating unit 220, and a plurality of LUTs 230. In each of the LUTs 230, for example, as illustrated in FIG. 17, the coefficient values in the LUTs are stored by being associated with the Nₐ addresses from 0 to Nₐ−1.

The address creating unit 220 calculates the address iₐ(|x(n−i)|) from the amplitude of the transmission signal data x(n) that is output from the BB processing device and then outputs the calculated address iₐ(|x(n−i)|) to each of the LUTs 230. Furthermore, i takes values from 0 to Q.

The number of LUTs 230 provided is (Q+1)×(Q+1). It is assumed that, in the array of the LUTs 230 illustrated in FIG. 16, the vertical direction is the i direction and the lateral direction is the j direction. The i^{th} address iₐ(|x(n−i)|) that is output from the address creating unit 220 is input to the i^{th} LUT 230 in each of the j columns. Each of the j columns, the sum total of the output from each of the LUTs 230 in the i direction is output to the distortion compensation processing unit 210. The coefficient value in each of the LUTs 230 is updated at predetermined timing by the coefficient updating unit 500.

By performing calculation of Equation (2) described above on the transmission signal data x(n) that is output from the BB processing device, the distortion compensation processing unit 210 generates the signal u(n) that has been subjected to distortion compensation. Then, the distortion compensation processing unit 210 outputs the generated signal u(n) that has been subjected to distortion compensation to the DAC 11 and the holding unit 310. The signal u(n) that is input to the DAC 11 is converted to the analog signal by the DAC 11, is modulated by the mixer 12 and the oscillator 13, is amplified to the predetermined power by the power amplifier 14, and is output from the antenna 15.

Second Distortion Compensation Unit 400

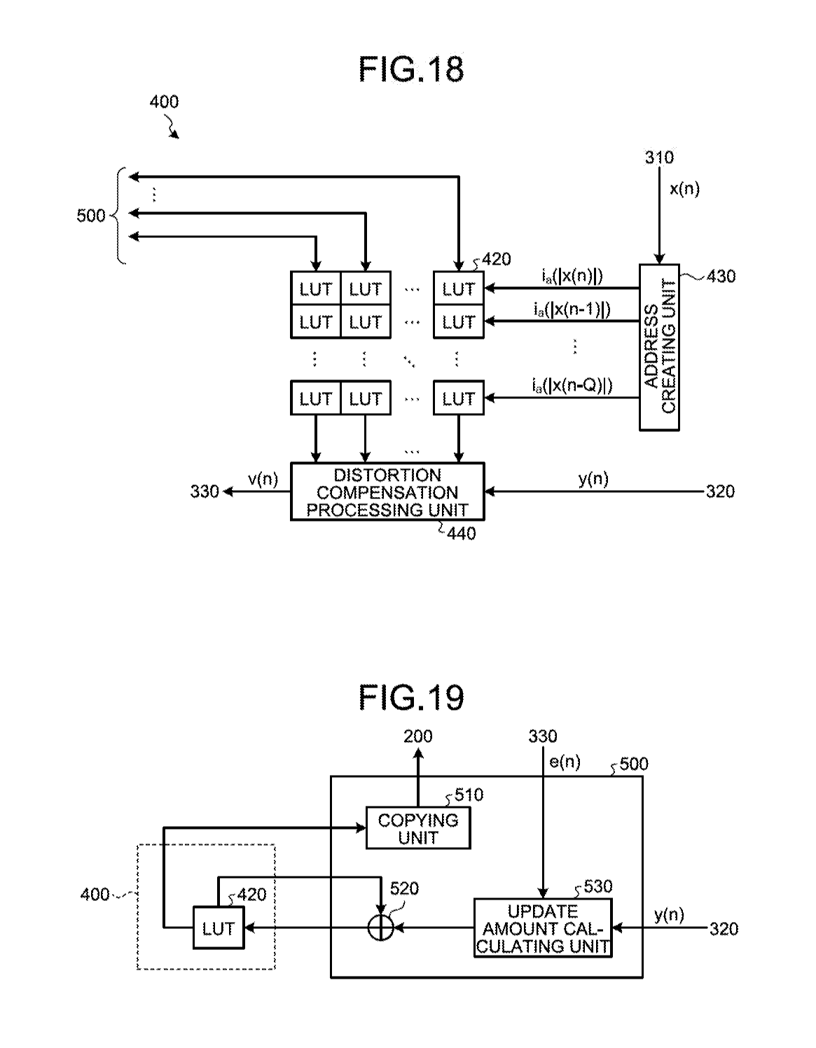

FIG. 18 is a schematic diagram illustrating an example of the second distortion compensation unit 400 according to the comparative example. The second distortion compensation unit 400 according to the comparative example includes, for example, as illustrated in FIG. 18, a plurality of LUTs 420, an address creating unit 430, and a distortion compensation processing unit 440. In each of the LUTs 420, for example, similarly to the LUT 230 illustrated in FIG. 17, the coefficient value stored in each of the LUTs is associated with each of Nₐ addresses from 0 to Nₐ−1.

The address creating unit 430 calculates the address iₐ(|x(n−i)|) from the amplitude of the transmission signal data x(n) stored in the holding unit 310 and outputs the calculated address iₐ(|x(n−i)|) to each of the LUTs 420.

Similarly to the LUTs 230 in the first distortion compensation unit 200, the (Q+1)×(Q+1) LUTs 420 are provided. In the array of the LUT 420 illustrated in FIG. 18, it is assumed that the vertical direction is the i direction and the lateral direction is the j direction. The i^{th} address iₐ(|x(n−i)|) output from the address creating unit 430 is input to the i^{th} LUT 420 in each of the j columns. In each of the j columns, the sum total of the outputs from each of the LUTs 420 in the i direction is output to the distortion compensation processing unit 440. The coefficient value in each of the LUTs 420 is sequentially updated by the coefficient updating unit 500.

The distortion compensation processing unit 440 generates the signal v(n) that has been subjected to distortion compensation by performing calculation of Equation (3) described above on the feedback signal y(n) held by the holding unit 320. Then, the distortion compensation processing unit 440 outputs the generated signal v(n) that has been subjected to distortion compensation to the subtracter 330.

The subtracter 330 calculates the error data e(n)=u(n)−v(n) based on the signal u(n) that has been subjected to distortion compensation and that is held by the holding unit 310 and based on the signal v(n) in which distortion has been compensated by the second distortion compensation unit 400 and then outputs the calculated error data e(n) to the coefficient updating unit 500.

FIG. 19 is a schematic diagram illustrating an example of the coefficient updating unit 500 according to the comparative example. The coefficient updating unit 500 according to the comparative example includes, for example, as illustrated in FIG. 19, a copying unit 510, an adder 520, and an update amount calculating unit 530.

The update amount calculating unit 530 calculates an update amount ΔL_{i,j} based on the calculation equation below by using the error data e(n) output from the subtracter 330 and the feedback signal y(n) held in the holding unit 320. Then, the update amount calculating unit 530 outputs the calculated update amount ΔL_{i,j} to the adder 520.

ΔL_{i,j}=μᵢⱼ·e(n)y(n−j)*

The adder 520 updates, based on the update amount ΔL_{i,j} output from the update amount calculating unit 530, by using the operation indicated by the equation below, the associated LUT coefficient L_{i,j}(|x(n−i)|) stored in the associated LUT 420 in the second distortion compensation unit 400.

L_{i,j}(|x(n−i)|)=L_{i,j}(|x(n−i)|)+ΔL_{i,j}

Furthermore, in FIG. 19, the single LUT 420 in the second distortion compensation unit 400 is illustrated; however, the update of the LUT coefficient is performed on each of the LUTs 420 specified by the combinations of i and j.

After the LUT coefficient in each of the LUTs 420 has been updated based on all of the signals y(n) in the holding unit 320, the copying unit 510 copies the data in each of the LUTs 420 in the second distortion compensation unit 400 to each of the LUTs 230 in the first distortion compensation unit 200. Consequently, the coefficients stored in each of the LUTs 230 in the first distortion compensation unit 200 are updated.

Adaptive Process of Coefficients in LUT Method

As a simple and effective update method of the LUT coefficients, there is a known Least Mean Square (LMS) method. In the LMS method, regarding the LUT coefficients, only the elements depending on the amplitudes |x(n)|, |x(n−1)|, . . . , and |x(n−Q)| of the transmission signal data x(n), x(n−1), . . . , and x(n−Q) at the present time are updated. The update amount is estimated from both the feedback signal and the error signal and the target coefficient is updated by the simple accumulated sum. Namely, the operation indicated by Equation (5) below is performed on each of i, j=0, 1, . . . , and Q.

L_{i,j}(|x(n−i)|)=L_{i,j}(|x(n−i)|)+ΔL_{i,j}

ΔL_{i,j}=μᵢⱼ·e(n)y(n−j)* (5)

In Equation (5) above, μᵢⱼ is a prescribed parameter and is referred to as a step coefficient.

Offset Problem

The distortion compensation performed by using the LUT method is represented by Equation (2) described above; however, formally, this is represented in the form of linear filtering as illustrated in Equation (6) below.

$$u ( n ) = {\sum }_{j = 0}^{Q} {L}_{j} ( {x}_{A} ( n ) ) x ( n - j ) \qquad ( 6 )$$

Here, the “linear” filter coefficient of each of the input signals can be obtained as the sum of a plurality of LUTs as indicated by Equation (7) below.

$${L}_{j} ( {x}_{A} ( n ) ) = {\sum }_{i = 0}^{Q} {L}_{i , j} ( \vert x ( n - i ) \vert ) \qquad ( 7 )$$

where, x_{A}(n)=(|x(n) |, |x(n−1) |, . . . , |x(n−Q)|).

In contrast, an update of coefficients performed in the LMS method, an update process is performed on the LUT coefficient L_{i,j}(|x(n−1)|) stored in the individual tables. At this time, the results of distortion compensation obtained from Equation (6) described above are the same as long as the result of the sum of Equations (7) above is the same. Thus, regarding each of the coefficients, it is found that the degree of freedom C_{i,j} that shifts the coefficients as follows is included.

$${L}_{i , j} ( \vert x ( n - i ) \vert ) \to {L}_{i , j} ( \vert x ( n - i ) \vert ) + {C}_{i , j} {\sum }_{i = 0}^{Q} {C}_{i , j} = 0 \qquad ( 8 )$$

Equation (8) above indicates that, in principle, regarding the elements of the individual LUTs, the amplitude thereof may possibly take extremely high value without affecting the characteristic of distortion compensation. In practice, this is a phenomenon observed in a real machine. Although this does not theoretically affect the characteristic, in a distortion compensation device that handles data subjected to sampling and quantization in order to perform digital processing, a high value exceeds the expression ability of the device to express the value. Thus, in the distortion compensation device in which the ability to express the value is finite, the degradation of the characteristics occurs.

As the technology that solves this offset problem, it is conceivable that the average value of the coefficients in the LUTs is estimated as offset and each of the coefficients in the LUTs is corrected by subtracting the estimated offset from each of the coefficients (hereinafter, this technology is referred to as a comparative example 1). In the method of the comparative example 1, when distortion compensation is performed, the coefficients are reproduced by adding the estimated offset. Furthermore, it is conceivable that when the value of each of the coefficients in the LUT is updated, accumulated offset can be reduced by multiplying the prescribed forgetting coefficient α (0<α<1) (hereinafter, this technology is referred to as a comparative example 2). However, in both the methods, the amount of processing in the process of suppressing the accumulation of offset is large.

In order to reduce the amount of processing in the process of suppressing the accumulation of the offset, the embodiments described below perform the following process.

Separation of Nonlinear Term and the Linear Term Included in the LUT

Equation (2) described above that is the LUT representation associated with the generalized memory polynomial model that serves as the reference includes not only the elements of the nonlinear term but also the elements of the linear term. Thus, in the embodiments described below, by returning to the definition of the conventional Volterra series, for example, as indicated by Equation (9) below, the linear term and the nonlinear term are faithfully separated and only the nonlinear term is listed in the LUT as a table.

$$u ( n ) = {\sum }_{j = 0}^{Q} {h}_{i , 1} x ( n - j ) + {\sum }_{j = 0}^{Q} ( {\sum }_{i = 0}^{Q} {\overline{L}}_{i , j} ( \vert x ( n - i ) \vert ) ) x ( n - j ) \qquad ( 9 )$$

Conditioning of LUT Coefficients in the Nonlinear Term

In Equation (9) above, conditioning is performed to guarantee that the LUT is the nonlinear term of the series model (if not, this is not distinguished from the formula based on the conventional LUT). For example, typically, if the associated series model depends on the signal amplitude, Equation (10) is satisfied.

L̅_{i,j}(iₐ=0)=0 (10)

Update Method of Coefficients

Regarding the LUT coefficients whose address value is not zero, the same coefficient update as the conventional coefficient update is performed as indicated by Equation (11) below.

L̅_{i,j}(|x(n−i)|)=L̅_{i,j}(|x(n−i)|)+μᵢⱼ·e(n)y(n−j)* (11)

Furthermore, similarly to the coefficient h_{j,1} in the linear term, as indicated by the equation below, the coefficient update is performed by performing cumulative addition of the update amount.

h_{j,1}=h_{j,1}+Δh_{j,1}

However, it is assumed that the update amount Δh_{j,1} is estimated from the other updated LUT coefficient L̅_{i,j}(|x(n−i)|) so as to satisfy the condition indicated by Equation (10) described above.

Furthermore, each of the coefficients of the linear term and the initial value of each of the coefficients in the nonlinear term are as follows.

h_{0,1}=1

h_{j,1}=1, where j≠0

L̅_{i,j}(|x(n−i)|)=0

### [a] First Embodiment

Configuration of a Distortion Compensation Device 10 According to a First Embodiment

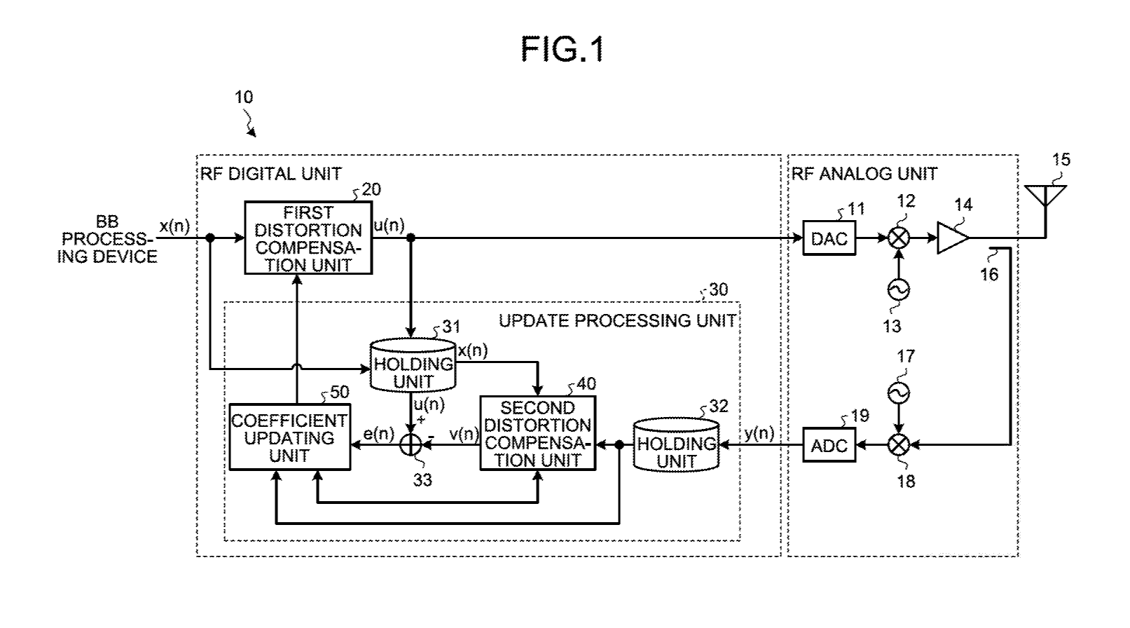

FIG. 1 is a block diagram illustrating an example of the distortion compensation device 10 according to a first embodiment. The distortion compensation device 10 according to the embodiment includes an RF digital unit, an RF analog unit, and the antenna 15. The RF analog unit includes the DAC 11, the mixer 12, the oscillator 13, the power amplifier 14, the coupler 16, the oscillator 17, the mixer 18, and the ADC 19. The RF digital unit includes a first distortion compensation unit 20 and an update processing unit 30. The update processing unit 30 includes a holding unit 31, a holding unit 32, a subtracter 33, a second distortion compensation unit 40, and a coefficient updating unit 50. Furthermore, in FIG. 1, because the blocks assigned the same reference numerals as those illustrated in FIG. 15 are the same blocks in the comparative example described with reference to FIG. 15, descriptions thereof in detail will be omitted.

Basic Assumption

In also the embodiment, the basic distortion compensation system indicated in the comparative example described above is assumed. Furthermore, in the embodiment, to give concrete expression, as the source of an input signal, a downlink (DL) signal of the mobile communication system, such as long term evolution (LTE), or the like, is assumed. As the processing unit in the time domain representation of a signal, for example, a frame in units of 10 milliseconds and a subframe in units of 1 millisecond are defined. The number of samples per frame is defined as Nₛₘₚ_{_}_{f} and the number of samples per subframe is defined as Nₛₘₚ_{_}_{sbf}. The other technical elements are basically followed by the definition of LTE.

Basic Operation

[1] In distortion compensation in the IDL method, there are two different distortion compensation blocks. In the embodiment, for example, the first distortion compensation unit 20 and the second distortion compensation unit 40 illustrated in FIG. 1 correspond to the subject blocks. These are operated in parallel in real time.
[2] Processing unit of the first distortion compensation unit 20

An update of the LUT coefficients is performed in units of frames and the updated LUT coefficients are applied to all of the pieces of the new data in the frame.

[3] Processing unit of the second distortion compensation unit 40

The temporal processing unit is the same as that of the first distortion compensation unit 20. However, an amount of sample data actually used for the update process of the coefficients is determined based on the buffer size of the holding unit 32 that is capable of holding the feedback data y(n). It is assumed that the prescribed buffer size of the holding unit 32 is N_{bf}. In the embodiment, N_{bf} is, for example, 2048.

### [4] Feedback Operation

It is assumed that the feedback data y(n) sequentially feeds back the transmission signal from the top of the frame for each prescribed buffer size (for example, for each N_{bf}=2048) and is stored in the holding unit 32.

[5] Coefficient update process performed by the coefficient updating unit 50

The distortion compensation process is performed, by the second distortion compensation unit 40 for each frame, on newly storing N_{bf} data sample in the buffer and the update process is performed, in parallel at each sample timing, on the coefficients stored in the LUT in the second distortion compensation unit 40.

Representation of Addresses in the LUT

The addresses in the LUT are associated by quantizing, with respect to the amplitude of the input signal x(n), at uniform intervals, the prescribed dynamic range [aₘᵢₙ, aₘₐₓ] by the number of bits qₐ. The addresses with respect to the amplitude of the input signal x(n) can possibly take values of a=0, . . . , and Nₐ−1, if Nₐ=2^{q}.

First Distortion Compensation Unit 20

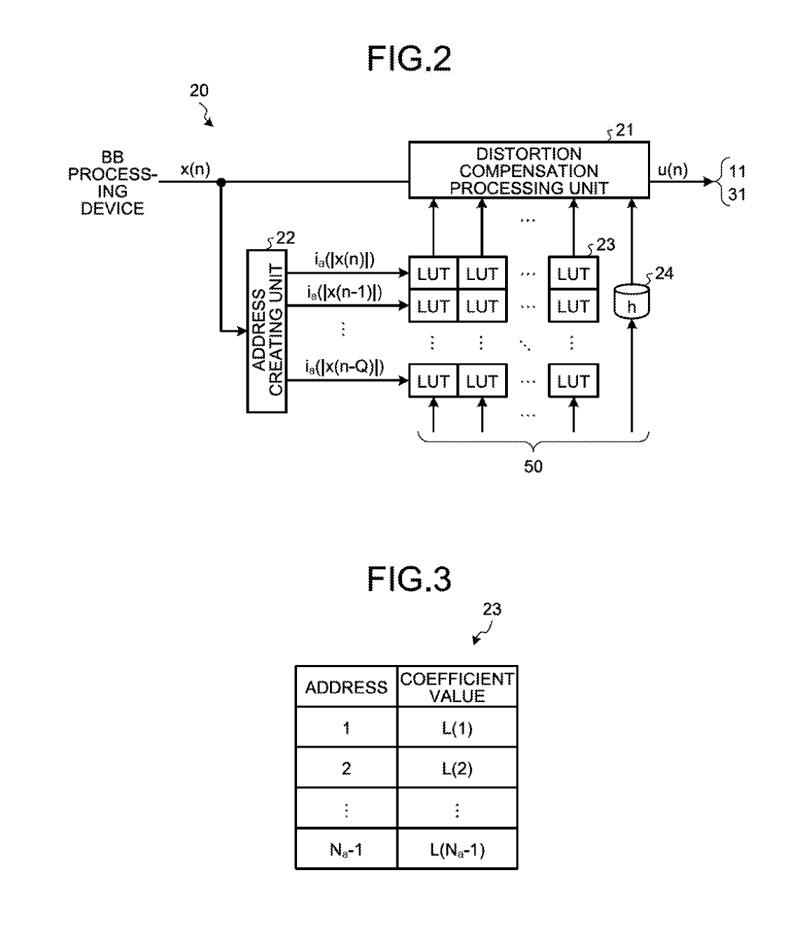

FIG. 2 is a schematic diagram illustrating an example of the first distortion compensation unit 20 according to the first embodiment. The first distortion compensation unit 20 according to the embodiment includes, for example, as illustrated in FIG. 2, a distortion compensation processing unit 21, an address creating unit 22, a plurality of LUTs 23, and a linear term coefficient table 24. In each of the LUTs 23, for example, as illustrated in FIG. 3, the coefficient value in the LUT is associated with each of the Nₐ−1 addresses of 1 to Nₐ−1. Namely, in each of the LUTs 23, the coefficient value in the LUT associated with the address with the value of 0 is not stored. In the following, the address with the value of 0 is sometimes referred to as the zero address. Each of the LUTs 23 is an example of a first table.

The address creating unit 22 calculates the address iₐ(|x(n−i)|) from the amplitude of the transmission signal data x(n) output from the BB processing device and then outputs the calculated address iₐ(|x(n−i)|) to each of the LUTs 23. Furthermore, i takes the values from 0 to Q.

The number of the LUTs 23 provided in the first distortion compensation unit 20 is (Q+1)×(Q+1). In the array of the LUTs 23 illustrated in FIG. 2, it is assumed that the vertical direction is the i direction and the lateral direction is the j direction. The i^{th} address iₐ(|x(n−i)|) output from the address creating unit 22 is input to the i^{th} LUT 23 in each of the j columns. In each of the j columns, the sum total of the outputs from the LUTs 23 in the i direction is output to the distortion compensation processing unit 21. The coefficient value in each of the LUTs 23 is updated by the coefficient updating unit 50 for, for example, each frame.

In the linear term coefficient table 24, the coefficient h_{j,1} of the Q+1 linear terms are stored. The coefficient h_{j,1} of each of the linear term stored in the linear term coefficient table 24 is updated by the coefficient updating unit 50 for, for example, each frame. The linear term coefficient table 24 is an example of a second table.

The distortion compensation processing unit 21 generates the signal u(n) that has been subjected to distortion compensation by performing Equation (9) described above on the transmission signal data x(n) output from the BB processing device. Then, the distortion compensation processing unit 21 outputs the generated signal u(n) that has been subjected to distortion compensation to the DAC 11 and the holding unit 31. The signal u(n) that is input to the DAC 11 is converted to an analog signal by the DAC 11, is modulated by the mixer 12 and the oscillator 13, is amplified to the predetermined power by the power amplifier 14, and is transmitted from the antenna 15.

Update Processing Unit 30

The update processing unit 30 includes the holding unit 31, the holding unit 32, the subtracter 33, the second distortion compensation unit 40, and the coefficient updating unit 50. The transmission signal data x(n) output from the BB processing device and the signal u(n) subjected to distortion compensation by the first distortion compensation unit 20 are held in the holding unit 31. Furthermore, the signal y(n) fed back from the RF analog unit is held in the holding unit 32.

Second Distortion Compensation Unit 40

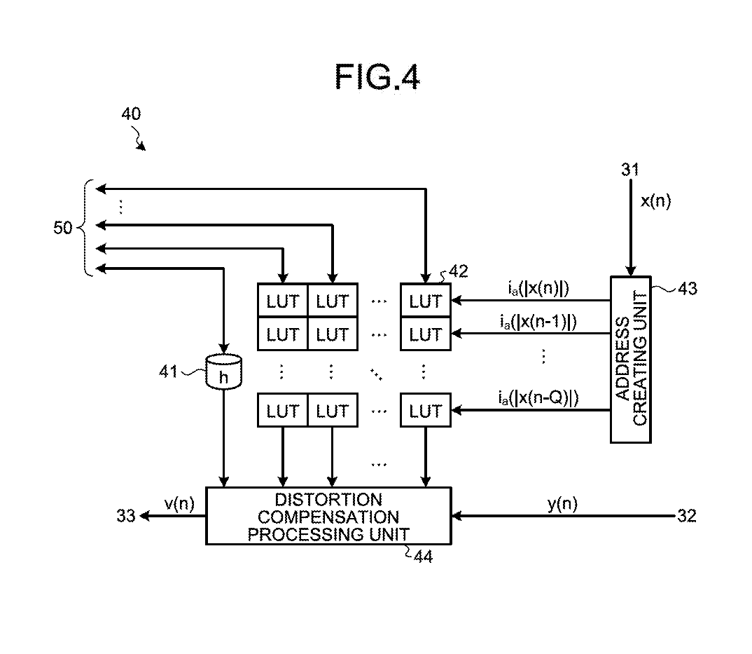

FIG. 4 is a schematic diagram illustrating an example of the second distortion compensation unit 40 according to the first embodiment. The second distortion compensation unit 40 according to the embodiment includes, for example, as illustrated in FIG. 4, a linear term coefficient table 41, a plurality of LUTs 42, an address creating unit 43, and a distortion compensation processing unit 44. In the linear term coefficient table 41, the coefficient h_{j,1} of Q+1 linear terms are stored. The coefficient h_{j,1} of the linear term in the linear term coefficient table 41 is sequentially updated by the coefficient update process performed by the coefficient updating unit 50, which will be described later. In each of the LUTs 42, for example, similarly to the LUT 23 illustrated in FIG. 3, the coefficient values of the LUT are associated with each of the Nₐ−1 addresses from 1 to Nₐ−1 and stored. Each of the LUTs 42 is an example of the first table. The linear term coefficient table 41 is an example of the second table.

The address creating unit 43 calculates the address iₐ(|x(n−i)|) from the amplitude of the transmission signal data x(n) held in the holding unit 31 and outputs the calculated address iₐ(|x(n−i)|) to each of the LUTs 42.

Similarly to the LUTs 23 in the first distortion compensation unit 20, the (Q+1)×(Q+1) LUTs 42 are provided. In the array of the LUTs 42 illustrated in FIG. 4, it is assumed that the vertical direction is the i direction and the lateral direction is the j direction. The i^{th} address iₐ(|x(n−i)|) output from the address creating unit 43 is input to the i^{th} LUT 42 in each of the j columns. In each of the j columns, the sum total of the outputs from the LUTs 42 in the i direction is output to the distortion compensation processing unit 44.

By using the distortion compensation coefficient that is held in the holding unit 31 and that is specified from the transmission signal data x(n), the distortion compensation processing unit 44 generates, with respect to the feedback signal y(n) held in the holding unit 32 by using the calculation equation below, the signal v(n) that has been subjected to distortion compensation. Then, the distortion compensation processing unit 44 outputs the generated signal v(n) that has been subjected to distortion compensation to the subtracter 33.

$$v ( n ) = {\sum }_{j = 0}^{Q} {h}_{j , 1} y ( n - j ) + {\sum }_{j = 0}^{Q} ( {\sum }_{i = 0}^{Q} {\overline{L}}_{i , j} ( \vert x ( n - i ) \vert ) ) y ( n - j )$$

The subtracter 33 calculates the error data e(n)=u(n)−v(n) based on the signal u(n) that has been subjected to distortion compensation and that is held in the holding unit 31 and based on the signal v(n) in which distortion has been compensated by the second distortion compensation unit 40 and then outputs the calculated error data e(n) to the coefficient updating unit 50.

Coefficient Updating Unit 50

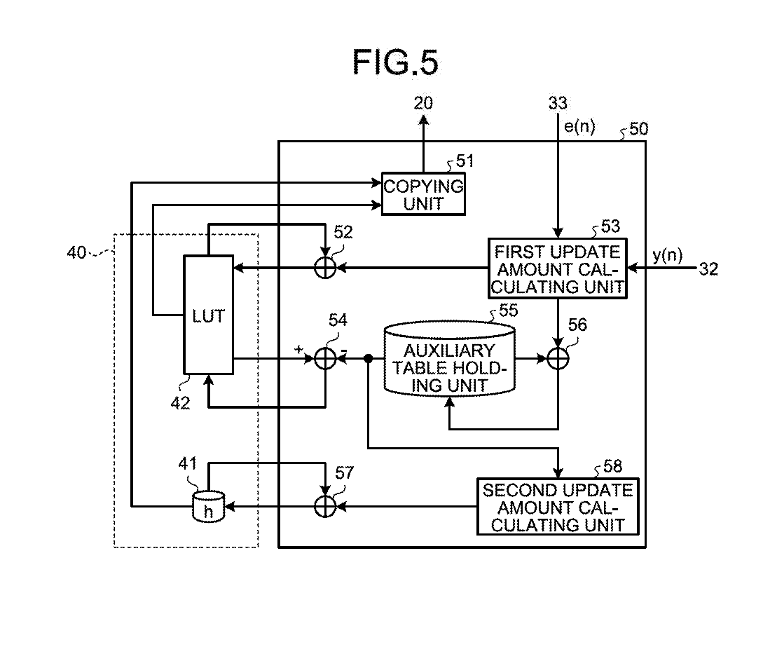

FIG. 5 is a schematic diagram illustrating an example of the coefficient updating unit 50 according to the first embodiment. The coefficient updating unit 50 according to the embodiment includes, for example, as illustrated in FIG. 5, a copying unit 51, an adder 52, a first update amount calculating unit 53, a subtracter 54, an auxiliary table holding unit 55, an adder 56, an adder 57, and a second update amount calculating unit 58. The adder 52 is an example of the first updating unit. The first update amount calculating unit 53 is an example of the calculating unit. The subtracter 54 is an example of the correcting unit. The adder 57 is an example of the second updating unit.

By using the error data e(n) output from the subtracter 33 and by using the feedback signal y(n) held in the holding unit 32, the first update amount calculating unit 53 calculates the update amount ΔL_{i,j} based on the calculation equation below.

ΔL_{i,j}=μᵢⱼ·e(n)y(n−j)*

Then, the first update amount calculating unit 53 outputs, to the adder 56, the update amount ΔL_{i,j} calculated regarding the LUT coefficient L̅_{i,j}(|x(n−i)|) of the nonlinear term to the adder 52 and outputs the update amount ΔL_{i,j} calculated regarding the LUT coefficient L̅_{i,j}(iₐ=0) of the linear term.

As indicated by Equation (12) below, the adder 52 updates the LUT coefficients in the LUT 42 by adding the update amount output from the first update amount calculating unit 53 to each of the LUT coefficients in the LUT 42.

L̅_{i,j}(|x(n−i)|)=L̅_{i,j}(|x(n−i)|)+ΔL_{i,j} (12)

The auxiliary table holding unit 55 holds the LUT coefficient L_{i,j,0}=L̅_{i,j}(iₐ=0) of the linear term at each of the delay timing j.

The adder 56 updates the LUT coefficients of the linear term in the auxiliary table holding unit 55 by adding the update amount ΔL_{i,j} of the LUT coefficient of the linear term output from the first update amount calculating unit 53 to the LUT coefficient of the linear term in the auxiliary table holding unit 55.

Regarding all of the signals y(n) in the holding unit 32, if the first update amount calculating unit 53 calculates the update of the LUT coefficients, the subtracter 54 uniformly subtracts, regarding each of the LUTs 42, the LUT coefficient of the linear term in the auxiliary table holding unit 55 from each of the coefficient values in the LUT 42.

Regarding all of the signals y(n) in the holding unit 32, if the first update amount calculating unit 53 calculates the update of the LUT coefficient, the second update amount calculating unit 58 calculates the update amount Δh_{j,1} of the linear term regarding each of the delay timings j. Specifically, the second update amount calculating unit 58 calculates the update amount Δh_{j,1} of the linear term by performing cumulative addition on the LUT coefficients of the linear term in the auxiliary table holding unit 55 using the operation indicated below for example.

Δh_{j,1}=Δh_{j,1}+L_{i,j,0}

The adder 57 updates the coefficient h_{j,1} of the linear term by performing cumulative addition using, for example, the operation indicated below, the update amount Δh_{j,1} calculated regarding each of the delay timings j by the second update amount calculating unit 58 to the coefficient h_{j,1} of the linear term in the linear term coefficient table 41.

h_{j,1}=h_{j,1}+Δh_{j,1}

Regarding all of the signals y(n) in the holding unit 32, if the first update amount calculating unit 53 calculates the update of the LUT coefficient, the copying unit 51 updates, based on the coefficients in the linear term coefficient table 41 and in each of the LUTs 42, the coefficient in the linear term coefficient table 24 and in each of the LUTs 23. Specifically, the copying unit 51 overwrites and copies the coefficients in the linear term coefficient table 41 to the linear term coefficient table 24 and overwrites and copies the coefficient in each of the LUTs 42 to the corresponding LUTs 23.

Distortion Compensation Process

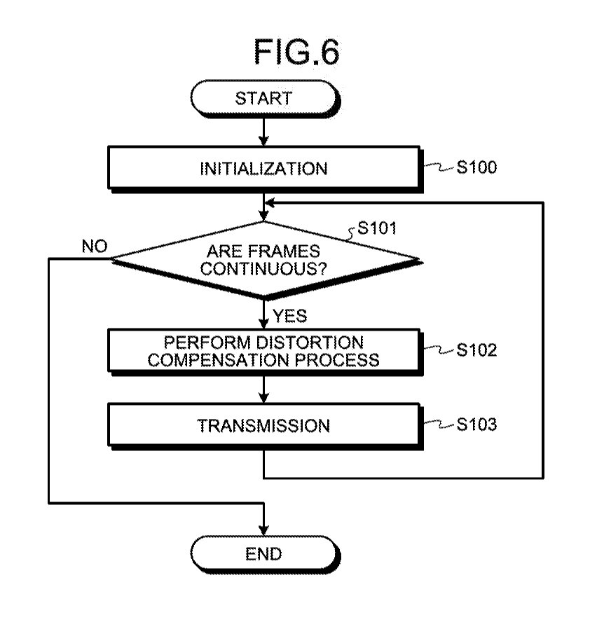

FIG. 6 is a flowchart illustrating an example of a distortion compensation process according to the first embodiment. When starting transmission of a DL signal, the distortion compensation device 10 starts the distortion compensation process indicated by the subject flowchart.

First, the first distortion compensation unit 20 initializes each of the LUTs 23 (Step S100). Specifically, the first distortion compensation unit 20 initializes the coefficient in each of the LUTs 23 to the value, for example, indicated below.

L_{0,0}(|x(n)|)=1

L_{i,j}(|x(n)|)=0, where i≠0 or j≠0

Then, the distortion compensation processing unit 21 determines whether the frame to be transmitted is continuous (Step S101). If the frame is continuous (Yes at Step S101), the distortion compensation processing unit 21 performs the distortion compensation process (Step S102). Specifically, by performing Equation (9) described above on the transmission signal data x(n) output from the BB processing device, the distortion compensation processing unit 21 performs the distortion compensation process and generates the signal u(n) that has been subjected to distortion compensation.

The signal u(n) that has been subjected to distortion compensation and that is generated by the distortion compensation processing unit 21 is output to the DAC 11, is converted to the analog signal by the DAC 11, is modulated by the mixer 12 and the oscillator 13, and is amplified to the predetermined power by the power amplifier 14. Then, the signal amplified to the predetermined power by the power amplifier 14 is transmitted from the antenna 15 (Step S103).

Then, the distortion compensation processing unit 21 again performs the process indicated at Step S101. If the frame to be transmitted is not continuous (No at step S101), the distortion compensation device 10 ends the distortion compensation process indicated in the flowchart.

Coefficient Update Process

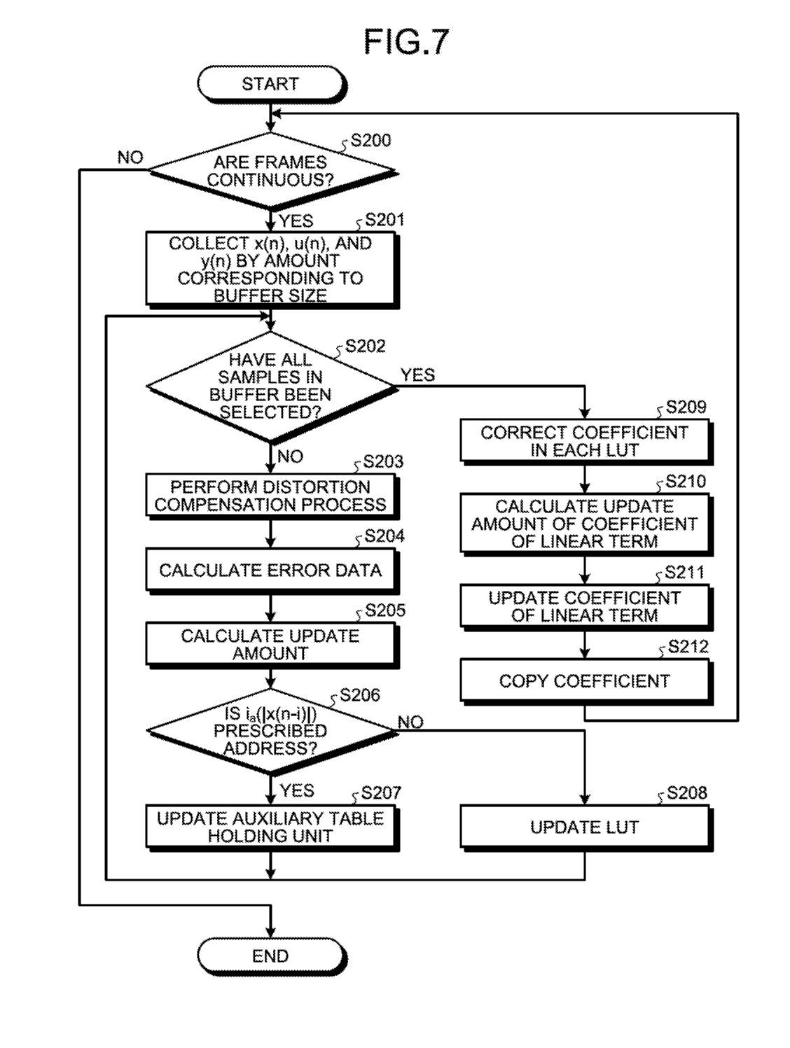

FIG. 7 is a flowchart illustrating an example of the coefficient update process according to the first embodiment. The distortion compensation device 10 performs, for example, for each frame, the coefficient update process illustrated in the flowchart.

First, the distortion compensation processing unit 44 determines whether the frame to be transmitted is continuous (Step S200). If the frame to be transmitted is not continuous (No at Step S200), the distortion compensation device 10 ends the coefficient update process illustrated in the flowchart.

In contrast, if the frame is continuous (Yes at Step S200), the holding unit 31 collects, by an amount corresponding to the predetermined buffer size, both the transmission signal data x(n) output from the BB processing device and the signal u(n) that has been subjected to distortion compensation by the first distortion compensation unit 20. Furthermore, the holding unit 32 collects, by an amount corresponding to the predetermined buffer size, the signal y(n) fed back from the RF analog unit (Step S201).

Then, the distortion compensation processing unit 44 determines whether all of the samples of the feedback signal y(n) in the buffer of the holding unit 32 have been selected (Step S202). If all of the samples of the feedback signal y(n) in the buffer of the holding unit 32 have not been selected (No at Step S202), the distortion compensation processing unit 44 performs a distortion correction process (Step S203). Specifically, the distortion compensation processing unit 44 generates the signal v(n) subjected to distortion compensation by performing the calculation equation described above on the feedback signal y(n) held in the holding unit 32 by using the distortion compensation coefficient that is specified transmission signal data x(n) held in the holding unit 31.

Then, the subtracter 33 calculates the error data e(n)=u(n)−v(n) based on the signal u(n) that has been subjected to distortion compensation and that is held in the holding unit 31 and based on the signal v(n) that has been subjected to distortion compensation and that is generated by the second distortion compensation unit 40 (Step S204).

Then, the first update amount calculating unit 53 calculates the update amount ΔL_{i,j} by using both the error data e(n) calculated by the subtracter 33 and the feedback signal y(n) held in the holding unit 32 (Step S205).

Then, the first update amount calculating unit 53 determines whether iₐ(|x(n−i)|) is the prescribed address (Step S206). In the embodiment, the prescribed address mentioned here is, for example, the zero address. Furthermore, the prescribed address does not need to be the zero address as long as the address has a small value. The address with a small value mentioned here is, for example, the address included in the range of, for example, 1% of the addresses starting from the address with the smallest value. If iₐ(|x(n−i)|) is the prescribed address (Yes at Step S206), the first update amount calculating unit 53 outputs the calculated update amount ΔL_{i,j} to the adder 56. The adder 56 adds the update amount ΔL_{i,j} of the LUT coefficient of the linear term output from the first update amount calculating unit 53 to the LUT coefficient of the linear term in the auxiliary table holding unit 55, thereby updating the LUT coefficient of the linear term in the auxiliary table holding unit 55 (Step S207). Then, the distortion compensation processing unit 44 again performs the process indicated at Step S202.

In contrast, if iₐ(|x(n−i)|) is not the prescribed address (No at Step S206), the first update amount calculating unit 53 outputs the calculated update amount ΔL_{i,j} to the adder 52. As indicated by Equation (12) above, the adder 52 updates the LUT coefficient in the LUT 42 by adding the update amount ΔL_{i,j} output from the first update amount calculating unit 53 to the LUT coefficient in the LUT 42 (Step S208). Then, the distortion compensation processing unit 44 again performs the process indicated at Step S202.

Furthermore, if the distortion compensation processing unit 44 has selected all of the samples of the feedback signal y(n) in the buffer (Yes at Step S202), the subtracter 54 corrects the coefficient in each of the LUTs 420 (Step S209). Specifically, regarding each of the LUTs 42, the subtracter 54 corrects the coefficient in each of the LUTs 42 by uniformly subtracting the LUT coefficient of the linear term in the auxiliary table holding unit 55 from each of the coefficient values in the LUT 42.

Then, the second update amount calculating unit 58 calculates the update amount Δh_{j,1} of the linear term by performing, regarding each of the delay timings j, cumulative addition on the LUT coefficient of the linear term in the auxiliary table holding unit 55 (Step S210). The adder 57 updates the coefficient h_{j,1} of the linear term by performing, regarding each of the delay timings j, cumulative addition on the update amount Δh_{j,1} calculated by the second update amount calculating unit 58 to the coefficient h_{j,1} of the linear term in the linear term coefficient table 41 (Step S211).

Then, the copying unit 51 copies the coefficients in the linear term coefficient table 41 to the linear term coefficient table 24 and copies the coefficient in each of the LUTs 42 to each of the LUTs 23 (Step S212). Then, the distortion compensation processing unit 44 again performs the process indicated at Step S200.

Effect of the First Embodiment

As described above, the distortion compensation device 10 according to the embodiment includes the LUT 42, the linear term coefficient table 41, the first update amount calculating unit 53, the subtracter 54, and the adder 57. The LUT 42 holds therein the coefficients of the nonlinear term, among the coefficients of the linear term and the nonlinear term included in the filtering coefficient used for the filtering of the input signal x(n), by associating the coefficients with the addresses other than the prescribed address calculated from the input signal x(n). The linear term coefficient table 41 holds therein the coefficient of the linear term of the prescribed address. Based on the output signal from the linear term coefficient table 41, the first update amount calculating unit 53 calculates each of the update amount of the coefficients of the nonlinear term and the update amount of the coefficients of the linear term. The subtracter 54 updates each of the coefficients in the LUT 42 based on the update amount of the coefficients of the nonlinear term. The adder 57 updates each of the coefficients in the linear term coefficient table 41 based on the update amount of the coefficients of the linear term.

Here, a reduction amount of the amount of processing with respect to the comparative example 1 and the comparative example 2 described above is specifically estimated based on the first embodiment. Here, the number of stages of the addresses in the LUT per plane is defined as Nₐ and the number of update samples per frame is defined as N_{bf}.

1) The Number of Addition Operations in the First Embodiment

In the distortion compensation device 10 according to the first embodiment, the operation in which a prescribed value is subtracted, for each frame, from all of the tables is performed. Thus, with the distortion compensation device 10 according to the first embodiment, the number of addition operations can be represented, for example, as follows.

2×(Q+1)×(Q+1)×Nₐ

2) Comparative Example 1 (Offset Estimation Method)

An offset estimation process and a correction process are performed for each frame. The addition operation for obtaining the average value and the operation of coefficient scaling (division by addition value) are performed for each plane of the LUT. The calculated offset estimated value is subtracted from the coefficients of all of the addresses. Furthermore, when the distortion compensation is processed, the estimated value of the offset is added to the coefficients of all of the addresses and the original coefficients are reproduced. Thus, the amount of operation in the comparative example 1 can be represented, for example, as follows.

2×(Q+1)×(Q+1)×Nₐ×3

The amount of operation in the comparative example 1 is three times greater than that in the first embodiment. Namely, in the process according to the first embodiment, the amount of operation can be reduced by about 67% when compared with the process in the comparative example 1.

3) Comparative Example 2 (Forgetting Method of LUT Coefficients)

Multiplication of forgetting coefficient is performed, for each sample subjected to update process that is performed per frame, on one of the update coefficients from each of the LUTs. The multiplication of forgetting coefficient can be replaced with the operation of shift and difference (two additions) as long as the coefficient is obtained from a difference between exponentiation with exponent 1 to ½. Thus, the amount of operation in the comparative example 2 can be represented, for example, as follows.

2×(Q+1)×(Q+1)×N_{bf}×2

At this point, if 2×N_{bf}x>Nₐ, the amount of operation according to the first embodiment becomes smaller. As an example of a specific value, if it is assumed that Nₐ=128 and N_{bf}=1024, the ratio of the amount of processing in the first embodiment to the amount of processing in the comparative example 1 is 1/16=0.0625. Thus, in the process according to the first embodiment, the amount of operation can be reduced by about 93% when compared with that performed in the comparative example 2.

Furthermore, the distortion compensation device 10 according to the embodiment described above includes the subtracter 54 that corrects each of the coefficients in the LUT 42 by subtracting the update amount of the coefficient of the linear term from each of the coefficients in the LUT 42. Furthermore, the adder 57 updates each of the coefficients of the linear term coefficient table 41 by performing cumulative addition on the update coefficient of the linear term for each delay timing. Consequently, the distortion compensation device 10 according to the embodiment can implement the process of suppressing the accumulation of offset with a small amount of processing.

### [b] Second Embodiment

In the first embodiment, every time the process performed on the feedback signal y(n) by an amount corresponding to the buffer size ends, a process of subtracting an update amount of a coefficient of the linear term from each of the coefficients in the LUT 42 is performed. This process is performed regardless of whether the update amount of the LUT coefficient of the zero address has been calculated. Thus, if the update amount of the LUT coefficient of the zero address is not calculated, a useless process is performed. In contrast, in the second embodiment, if the update amount of the LUT coefficient of the zero address is calculated, a process of subtracting an update amount of a coefficient of the linear term from each of the coefficients in the LUT 42 is performed. Consequently, the amount of processing in the process of suppressing the accumulation of offset can be further reduced.

Furthermore, in also the second embodiment, a coefficient value associated with the zero address is not allocated to each of the LUTs 23 and each of the LUTs 42. Furthermore, in a description below, if a signal that becomes iₐ(|x(n−i) |)=0 with respect to the input data appears, the update amount of the subject LUT is defined as ΔL_{i,j,0} is uniformly subtracted from all of the coefficients L̅_{i,j}(|x(n−i)|) in the LUT associated with the combinations of i and j.

Here, ΔL_{i,j,0} is calculated from Equation (13) below.

ΔL_{i,j,0}=μᵢⱼ·e(n)y(n−j)* (13)

Then, ΔL_{i,k,0} is accumulated as the update amount of the linear term by using Equation (14) below.

Δh_{j,1}=Δh_{j,1}+L_{i,j,0} (14)

Furthermore, the outline of the distortion compensation device 10, the first distortion compensation unit 20, the update processing unit 30, and the second distortion compensation unit 40 according to the second embodiment is the same as the distortion compensation device 10, the first distortion compensation unit 20, the update processing unit 30, and the second distortion compensation unit 40 according to the first embodiment described with reference to FIGS. 1 to 4. Therefore, descriptions thereof in detail will be omitted.

Coefficient Updating Unit 50

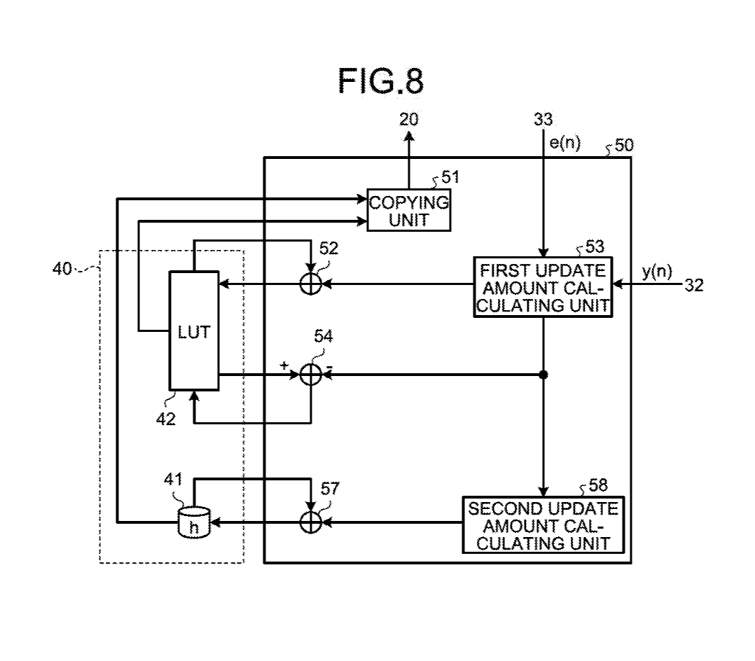

FIG. 8 is a schematic diagram illustrating an example of the coefficient updating unit 50 according to a second embodiment. The coefficient updating unit 50 according to the embodiment includes, for example, as illustrated in FIG. 8, the copying unit 51, the adder 52, the first update amount calculating unit 53, the subtracter 54, the adder 57, and the second update amount calculating unit 58. The blocks illustrated in FIG. 8 having the same reference numerals as those illustrated in FIG. 5 have the same functions as the blocks illustrated in FIG. 5 except for the following points described below; therefore, descriptions thereof will be omitted.

The first update amount calculating unit 53 calculates the update amount ΔL_{i,j} by using both the error data e(n) output from the subtracter 33 and the feedback signal y(n) held in the holding unit 32. Then, the first update amount calculating unit 53 outputs the update amount ΔL_{i,j} calculated about the LUT coefficient L̅_{i,j}(x|(n−i)|) of the nonlinear term to the adder 52 and outputs the update amount ΔL_{i,j,0} calculated about the LUT coefficient L̅_{i,j}(iₐ=0)=0 of the linear term to the subtracter 54 and the second update amount calculating unit 58.

If the update amount ΔL_{i,j,0} is output from the first update amount calculating unit 53, the subtracter 54 uniformly subtracts, regarding each of the LUTs 42, the update amount ΔL_{i,j,0} from each of the coefficient values in the LUT 42.

If the update amount ΔL_{i,j,0} is output from the first update amount calculating unit 53, the second update amount calculating unit 58 calculates the update amount Δh_{j,1} of the linear term by performing, regarding each of the delay timing j, cumulative addition on the update amount ΔL_{i,j,0} by using the same operation as that used in the first embodiment.

Coefficient Update Process

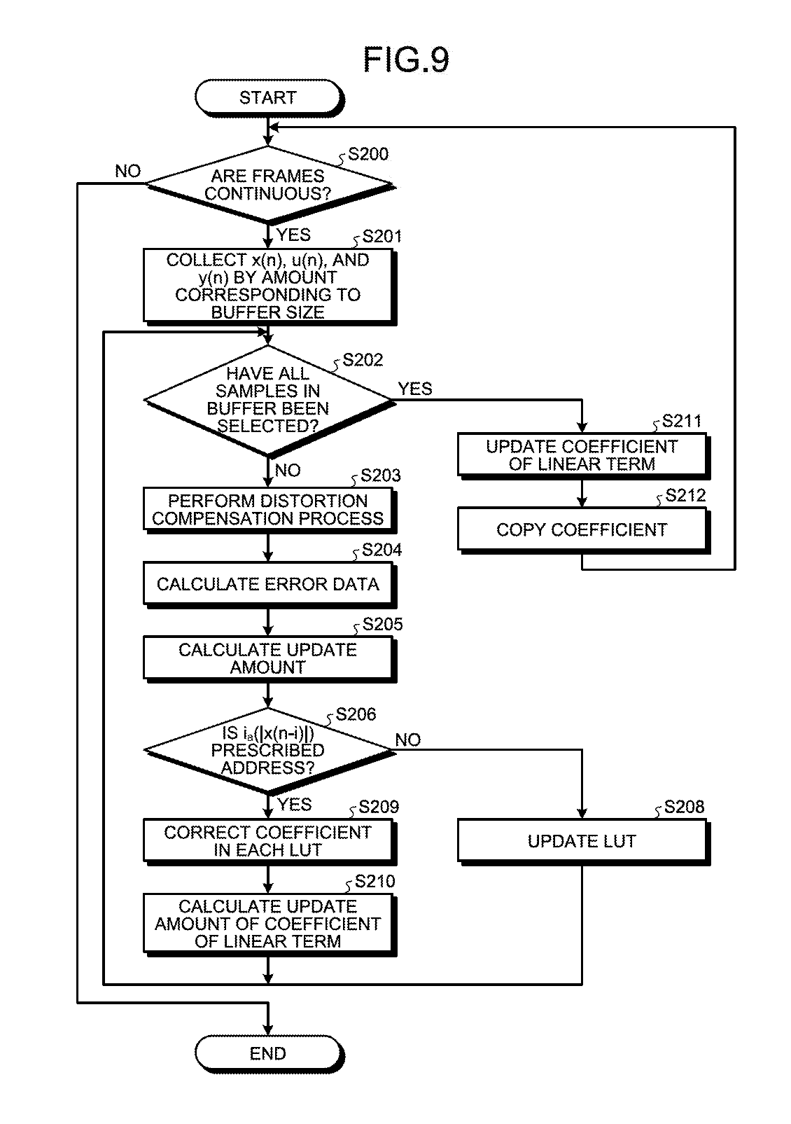

FIG. 9 is a flowchart illustrating an example of a coefficient update process according to the second embodiment. Furthermore, the processes illustrated in FIG. 9 having the same reference numerals as those illustrated in FIG. 7 have the same processes as those illustrated in FIG. 7 except for the following points described below; therefore, descriptions thereof will be omitted.

At Step S206, the first update amount calculating unit 53 determines whether iₐ(|x(n−i)|) is a prescribed address (Step S206). If iₐ(|x(n−i)|) is the prescribed address (Yes at Step S206), the first update amount calculating unit 53 outputs the update amount ΔL_{i,j,0} calculated at Step S205 to the subtracter 54 and the second update amount calculating unit 58. The subtracter 54 corrects the coefficient in each of the LUTs 42 by uniformly subtracting, regarding each of the LUTs 42, the update amount ΔL_{i,j,0} from each of the coefficient values in the LUT 42 (Step S209).

Then, regarding each of the delay timing j, the second update amount calculating unit 58 calculates the update amount Δh_{j,1} of the linear term by performing cumulative addition on the update amount ΔL_{i,j,0} output from the first update amount calculating unit 53 (Step S210). Then, the distortion compensation processing unit 44 again performs the process indicated at Step S202.

Furthermore, if the distortion compensation processing unit 44 has selected all of the samples of the feedback signal y(n) in the buffer (Yes at Step S202), the adder 57 updates, regarding each of the delay timing j, the coefficient h of the linear term (Step S211). Specifically, regarding each of the delay timing j, the adder 57 updates the coefficient h_{j,1} of the linear term by performing cumulative addition on the update amount Δh_{j,1} calculated by the second update amount calculating unit 58 with respect to the coefficient h of the linear term in the linear term coefficient table 41. Then, the copying unit 51 performs the process indicated by Step S212.

Effect of the Second Embodiment

As described above, in the embodiment, if the update amount of the coefficient of the linear term is calculated by the first update amount calculating unit 53, the subtracter 54 corrects each of the coefficients in the LUT 42 based on the calculated update amount of the coefficient of the linear term. Consequently, the amount of processing in the process of suppressing the accumulation of offset can be further reduced.

### [c] Third Embodiment

In the first embodiment, the process of uniformly subtracting the update amount of the coefficient of the linear term from each of the coefficients in the LUT 42 is performed. In contrast, in a third embodiment, each of the coefficients of the nonlinear term is updated as long as the coefficients are continuous between the adjacent addresses when the coefficient of the linear term is set to zero.

Specifically, the update of the LUT coefficient of the nonlinear term is performed based on Equation (15) below.

L̅_{i,j}(|x(n−i)|)=L̅_{i,j}(|x(n−i)|)+μᵢⱼ·e(n)y(n−j)* (15)

where, each of the LUT coefficients L̅_{i,j}(iₐ=0)=0 is updated as long as maintaining the continuity.

A specific condition of the update is as follows. Namely, the coefficient associated with the address iₐ in the LUT associated with each of the combinations of i and j is updated so as to become values within a predetermined range as indicated by, for example, Equation (16) below based on the value of the coefficient associated with immediately adjacent to the address.

L̅_{i,j}(iₐ−1)−Th<L̅_{i,j}(iₐ)<L̅_{i,j}(iₐ−1)+Th (16)

In Equation (16) above, Th is a prescribed threshold.

Furthermore, the update of the coefficient of the linear term is performed by the operation indicated by Equation (17) below.

h_{j,1}=h_{j,1}+μ_{i,j}·e(n)y(n−j)* (17)

Furthermore, the outline of the distortion compensation device 10, the first distortion compensation unit 20, the update processing unit 30, and the second distortion compensation unit 40 according to the third embodiment is the same as the distortion compensation device 10, the first distortion compensation unit 20, the update processing unit 30, and the second distortion compensation unit 40 according to the first embodiment described with reference to FIGS. 1 to 4. Thus, descriptions in detail thereof will be omitted.

Coefficient Updating Unit 50

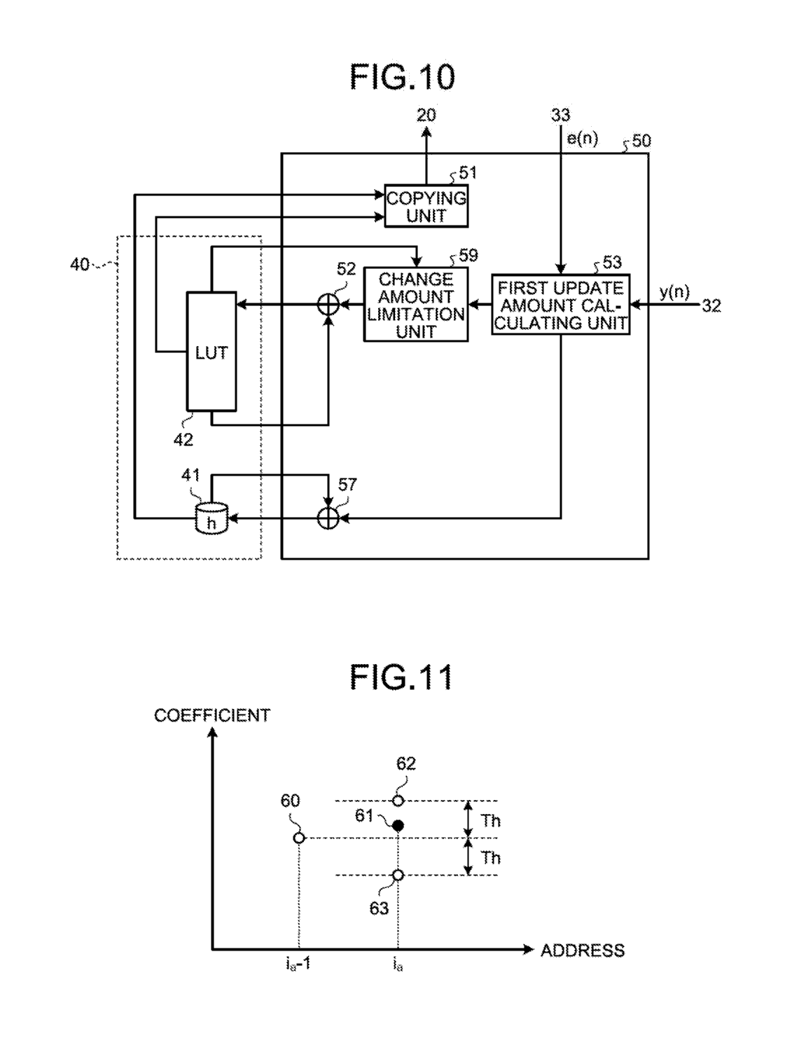

FIG. 10 is a schematic diagram illustrating an example of the coefficient updating unit 50 according to a third embodiment. A coefficient updating unit 50 according to the embodiment includes, for example, as illustrated in FIG. 10, the copying unit 51, the adder 52, a first update amount calculating unit 53, the adder 57, and a change amount limitation unit 59. Furthermore, the blocks illustrated in FIG. 10 having the same reference numerals as those illustrated in FIG. 5 have the same functions as the blocks illustrated in FIG. 5 except for the following points described below; therefore, descriptions thereof will be omitted.

The first update amount calculating unit 53 calculates the update amount ΔL_{i,j} by using both the error data e(n) output from the subtracter 33 and the feedback signal y(n) held by the holding unit 32. Then, the first update amount calculating unit 53 outputs the update amount ΔL_{i,j} calculated about the LUT coefficients of the nonlinear term other than the zero address to the change amount limitation unit 59. Furthermore, the first update amount calculating unit 53 outputs the update amount ΔL_{i,j} calculated about each of the LUT coefficients including the zero address to the adder 57.

If the update amount ΔL_{i,j} is output from the first update amount calculating unit 53, the change amount limitation unit 59 acquires, from the LUT 42, the LUT coefficient of the associated address and the LUT coefficient of the address adjacent to the associated address (in the embodiment, the address with a value decremented by 1). Then, the change amount limitation unit 59 performs the update amount limitation process that limits the update amount ΔL_{i,j} output from the first update amount calculating unit 53 such that Equation (16) above is satisfied.

FIG. 11 is a schematic diagram illustrating an example of an update amount limitation process. For example, if the update amount ΔL_{i,j} associated with the address iₐ is output form the first update amount calculating unit 53, the change amount limitation unit 59 adds the subject update amount ΔL_{i,j} to the LUT coefficient associated with the address iₐ. A point 61 illustrated in FIG. 11 indicates the result of adding the update amount ΔL_{i,j} to the LUT coefficient associated with the address iₐ.

Then, the change amount limitation unit 59 acquires, from the LUT 42, the LUT coefficient (a point 60 illustrated in FIG. 11) of the address iₐ−1 that is lower than the address iₐ by 1. Then, the change amount limitation unit 59 compares the value obtained by adding the threshold Th to the acquired LUT coefficient and the value obtained by subtracting the threshold Th from the subject LUT coefficient with the result of adding the update amount ΔL_{i,j} to the LUT coefficient of the address iₐ. Because the point 61 illustrated in FIG. 11 is the value between the value obtained by adding the threshold Th to the LUT coefficient of the address iₐ−1 and the value obtained by subtracting the threshold Th from the subject LUT coefficient, the change amount limitation unit 59 outputs the update amount ΔL_{i,j} calculated about the address iₐ to the adder 52.

Furthermore, if the value obtained by adding the update amount ΔL_{i,j} to the LUT coefficient of the address iₐ is greater than the value obtained by adding the threshold Th to the LUT coefficient of the address iₐ−1, the change amount limitation unit 59 replaces the subject update amount ΔL_{i,j} with the update amount ΔL′_{i,j} such that the added LUT coefficient becomes the value indicated by a point 62 illustrated in FIG. 11. Then, the change amount limitation unit 59 outputs the replaced update amount ΔL′_{i,j} to the adder 52. Furthermore, if the value obtaining by adding the update amount ΔL_{i,j} to the LUT coefficient of the address iₐ is smaller than the value obtained by subtracting the threshold Th from the LUT coefficient of the address iₐ−1, the change amount limitation unit 59 replaces the subject update amount ΔL_{i,j} with the update amount ΔL′_{i,j} such that the added LUT coefficient becomes the value indicated by a point 63 illustrated in FIG. 11. Then, the change amount limitation unit 59 outputs the replaced update amount ΔL′_{i,j} to the adder 52. Consequently, the LUT coefficient of each of the addresses is updated while maintaining the continuity of the LUT coefficients between the adjacent addresses in each of the LUTs.

The adder 57 updates the coefficient of the linear term in the linear term coefficient table 41 by performing, based on Equation (17) above, cumulative addition on the update amount output from the first update amount calculating unit 53.

Coefficient Update Process

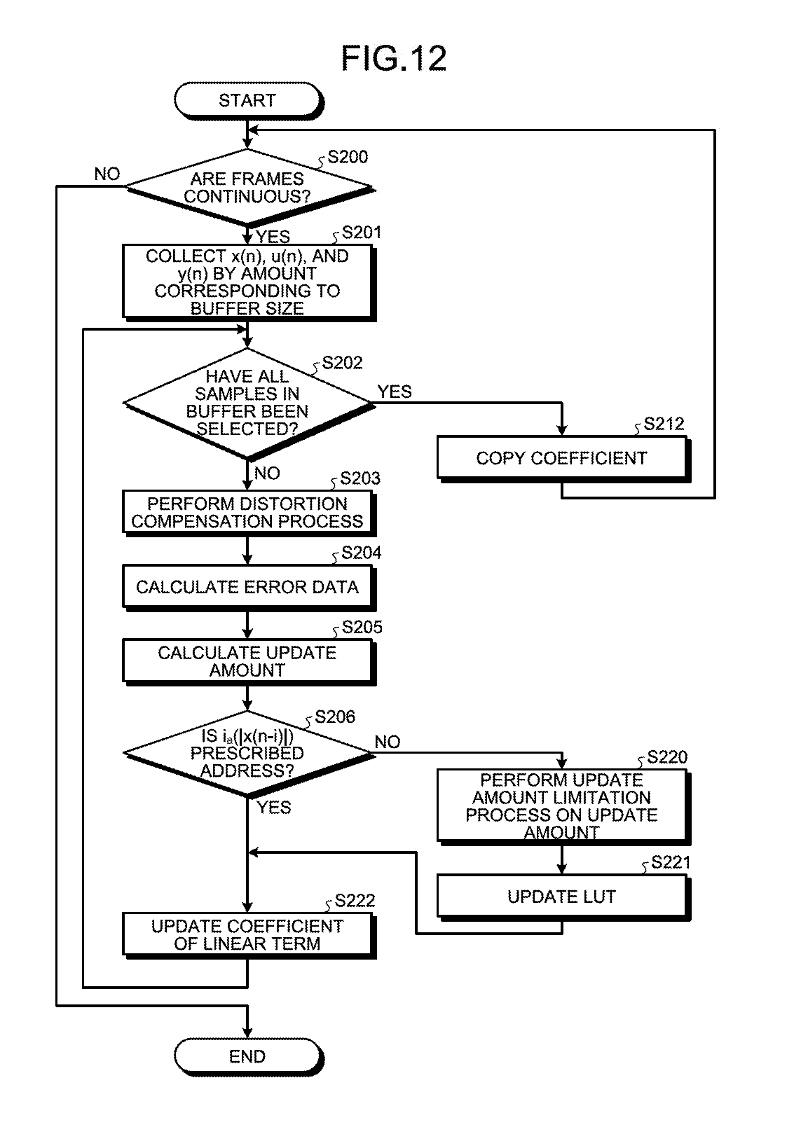

FIG. 12 is a flowchart illustrating an example of a coefficient update process according to the third embodiment. Furthermore, the processes illustrated in FIG. 12 having the same reference numerals as those illustrated in FIG. 7 have the same processes as those illustrated in FIG. 7 except for the following points described below; therefore, descriptions thereof will be omitted.

At Step S206, the first update amount calculating unit 53 determines whether iₐ(|x(n−i)|) is the prescribed address (Step S206). If iₐ(|x(n−i)|) is the prescribed address (Yes at Step S206), the first update amount calculating unit 53 outputs the update amount ΔL_{i,j,0} calculated at Step S205 to the adder 57. The adder 57 performs the process indicated by Step S222.

In contrast, if iₐ(|x(n−i)|) is not the prescribed address (No at Step S206), the first update amount calculating unit 53 outputs the update amount ΔL_{i,j} calculated at Step S205 to the adder 57 and the change amount limitation unit 59.

Then, the change amount limitation unit 59 performs the update amount limitation process that limits the update amount ΔL_{i,j} output from the first update amount calculating unit 53 so as to satisfy Equation (16) above (Step S220). Then, the change amount limitation unit 59 outputs the limited update amount ΔL_{i,j} to the adder 52. The adder 52 updates the LUT coefficient in the LUT 42 by adding the update amount ΔL_{i,j} output from the change amount limitation unit 59 (Step S221).

Then, regarding each of the delay timing j, the adder 57 updates the coefficient h of the linear term based on Equation (17) above by using the update amount output from the first update amount calculating unit 53 (Step S222). Then, the distortion compensation processing unit 44 again performs the process indicated at Step S202.

Effect of the Third Embodiment

As described above, in the third embodiment, the adder 52 performs the update such that the value of the coefficient associated with each of the addresses in the LUT 42 so as to satisfy the continuity based on the value of the coefficient of the linear term associated with the prescribed address. Consequently, the amount of processing in the process of suppressing the accumulation of offset can be reduced and, in each of the LUTs 42, it is possible to prevent variation in the value of the LUT coefficient between the adjacent addresses. Consequently, it is possible to suppress a decrease in distortion compensation performance due to an update of the LUT coefficient.

Furthermore, in the third embodiment described above, regarding the coefficient of each of the addresses in the LUT 42, the adder 52 performs the update such that the value of the coefficient of the update target address becomes the value within the predetermined range from the value of the coefficient of the address that is adjacent to the update target address. Consequently, the adder 52 can update the coefficient in the LUT 42 such that the value of the coefficient associated with each of the addresses in the LUT 42 satisfies the continuity.

Hardware

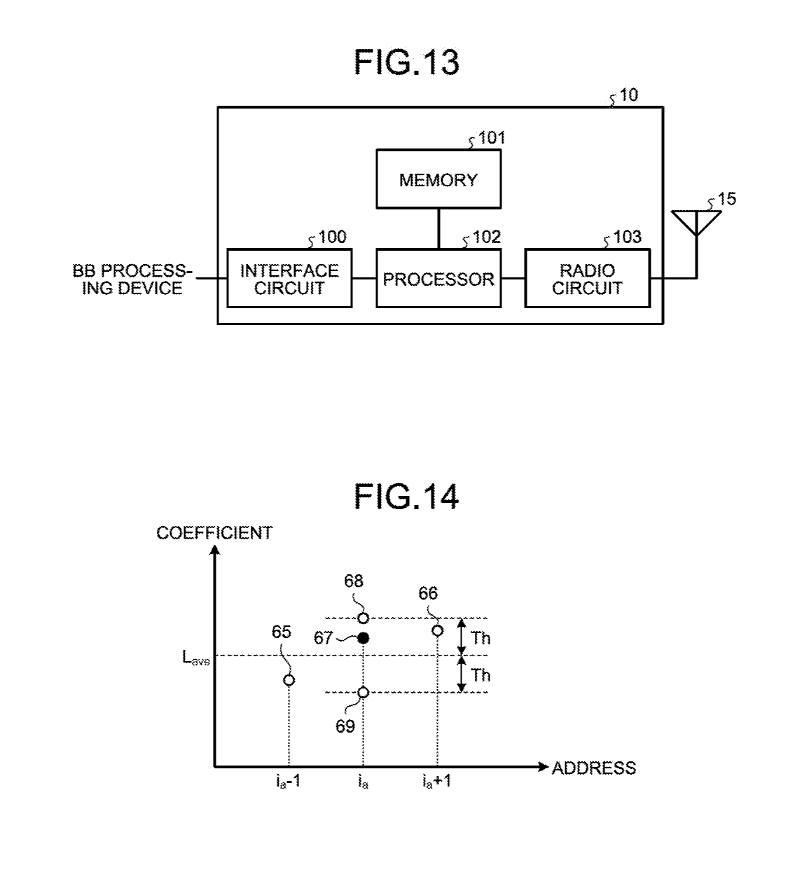

The distortion compensation device 10 according to the first to the third embodiments is implemented by the hardware illustrated in, for example, FIG. 13. FIG. 13 is a schematic diagram illustrating an example of hardware of the distortion compensation device 10. The distortion compensation device 10 includes, for example, as illustrated in FIG. 13, an interface circuit 100, a memory 101, a processor 102, a radio circuit 103, and an antenna 15.

The interface circuit 100 is an interface for performing wired communication with the BB processing device. The radio circuit 103 includes a power amplifier 14, or the like. The radio circuit 103 performs a process, such as up-conversion, or the like, on the signal output from the processor 102, amplifies the processed signal by the power amplifier 14, and transmits the signal from the antenna 15. Furthermore, the radio circuit 103 performs a process, such down-conversion, or the like, on a part of the signal amplified by the power amplifier 14 and feeds back the processed signal to the processor 102. In the radio circuit 103, for example, the DAC 11, the mixer 12, the oscillator 13, the power amplifier 14, the coupler 16, the oscillator 17, the mixer 18, and the ADC 19 are included.

The memory 101 stores therein various kinds of programs or the like for implementing the function of, for example, the first distortion compensation unit 20 and the update processing unit 30. The processor 102 implements each of the functions of, for example, the first distortion compensation unit 20 and the update processing unit 30 by executing the programs read from the memory 101.

Furthermore, in the distortion compensation device 10 illustrated in FIG. 13 as an example, the number of each of the processor 102, the radio circuit 103, and the antenna 15 is one; however, a plurality of the processors 102, the radio circuits 103, and the antennas 15 may also be provided in the distortion compensation device 10.

Furthermore, the programs, the data, or the like in the memory 101 described above does not need to be stored in the memory 101 from the beginning. For example, each program, the data, or the like may also be stored in a portable recording medium, such as a memory card, or the like, inserted in the distortion compensation device 10 and the distortion compensation device 10 may also acquire each of the programs, the data, or the like from the portable recording medium and executes the programs. Furthermore, the distortion compensation device 10 may also acquire each of the programs from another computer, a server device, or the like that stores therein each program, the data, or the like via a wireless communication line, a public circuit, the Internet, a LAN, a WAN, or the like.

Others

Furthermore, the technology disclosed in the present application is not limited to the embodiments described above and various modifications are possible as long as they do not depart from the spirit of the present application.

For example, in the third embodiment described above, regarding the update amount ΔL_{i,j} of the LUT coefficient of the address iₐ, the change amount limitation unit 59 performs the update amount limitation process that limits the update amount ΔL_{i,j} output from the first update amount calculating unit 53 so as to satisfy Equation (16) above. However, the disclosed technology is not limited to the disclosed application and the update amount limitation process is not limited to the process described in the third embodiment as long as the value of the coefficient associated with each of the addresses in the LUT 42 is updated so as to satisfy the continuity.

FIG. 14 is a schematic diagram illustrating another example of the update amount limitation process. For example, if the update amount ΔL_{i,j} associated with the address iₐ is output from the first update amount calculating unit 53, the change amount limitation unit 59 adds the subject update amount ΔL_{i,j} to the LUT coefficient associated with the address iₐ. A point 67 illustrated in FIG. 14 indicates the result of adding the update amount ΔL_{i,j} to the LUT coefficient associated with the address iₐ.

Then, the change amount limitation unit 59 calculates the average value Lₐᵥₑ between the LUT coefficient of the address iₐ−1 and the LUT coefficient of iₐ+1 (a point 65 and a point 66 illustrated in FIG. 14) that are adjacent to the address iₐ. Then, the change amount limitation unit 59 compares the result of adding the update amount ΔL_{i,j} to the LUT coefficient of the address iₐ with the value obtained by adding the threshold Th to the average value Lₐᵥₑ and the value obtained by subtracting the threshold Th from the subject average value Lₐᵥₑ. Because the point 67 illustrated in FIG. 14 is the value between the value obtained by adding the threshold Th to the average value Lₐᵥₑ and the value obtained by subtracting the threshold Th from the subject average value Lₐᵥₑ, the change amount limitation unit 59 outputs the update amount ΔL_{i,j} calculated about the address iₐ to the adder 52.

Furthermore, if the value obtained by adding the update amount ΔL_{i,j} to the LUT coefficient of the address iₐ is greater than the value obtained by adding the threshold Th to the average value Lₐᵥₑ, the change amount limitation unit 59 replaces the subject update amount ΔL_{i,j} with the update amount ΔL′_{i,j} such that the added LUT coefficient becomes the value indicated by a point 68 illustrated in FIG. 14. Then, the change amount limitation unit 59 outputs the replaced update amount ΔL′_{i,j} to the adder 52. Furthermore, if the value obtained by adding the update amount ΔL_{i,j} to the LUT coefficient of the address iₐ is smaller than the value obtained by subtracting the threshold Th from the average value Lₐᵥₑ, the change amount limitation unit 59 replaces the subject update amount ΔL_{i,j} with the update amount ΔL′_{i,j} such that the added LUT coefficient becomes the value indicated by a point 69 illustrated in FIG. 14. Then, the change amount limitation unit 59 outputs the replaced update amount ΔL′_{i,j} to the adder 52.

In this way, the adder 52 updates the coefficient of each of the addresses in the LUT 42 such that the value of the coefficient associated with the update target address becomes the value within the predetermined range from the average value of the coefficient of the two addresses that are adjacent to the subject update target address. Consequently, the adder 52 can update each of the coefficients in the LUT 42 such that the value of the coefficient associated with each of the addresses in the LUT 42 satisfies the continuity with a simple process.

According to an aspect of an embodiment, it is possible to reduce an amount of processing in a process of suppressing the accumulation of offset.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distortion compensation device that compensates, by filtering an input signal that is input to a power amplifier, distortion of an output signal that is output from the power amplifier, the distortion compensation device comprising:
a first table that holds, among a coefficient of a linear term and a coefficient of a nonlinear term that are included in filtering coefficients used for filtering of the input signal, the coefficient of the nonlinear term associated with an address other than a prescribed address obtained from the input signal;
a second table that holds the coefficient of the linear term related to the prescribed address;
a calculating unit that calculates, based on the output signal, each of an update amount of the coefficient of the nonlinear term and an update amount of the coefficient of the linear term;
a first updating unit that updates, based on the update amount of the coefficient of the nonlinear term, each of the coefficients in the first table; and
a second updating unit that updates, based on the update amount of the coefficient of the linear term, each of the coefficients in the second table.

2. The distortion compensation device according to claim 1, further comprising a correcting unit that corrects each of the coefficients in the first table by subtracting the update amount of the coefficient of the linear term from each of the coefficients in the first table, wherein
the second updating unit updates each of the coefficients in the second table by performing, for each delay timing, cumulative addition on the updated coefficients of the linear term.

3. The distortion compensation device according to claim 2, wherein, when the update amount of the coefficient of the linear term is calculated by the calculating unit, the correcting unit corrects each of the coefficients in the first table based on the update amount of the calculated coefficient of the linear term.

4. The distortion compensation device according to claim 1, wherein the first updating unit updates a value of the coefficient associated with each of the addresses in the first table so as to satisfy continuity based on the value of the coefficient of the linear term associated with the prescribed address.

5. The distortion compensation device according to claim 4, wherein the first updating unit updates, regarding the coefficient associated with each of the addresses in the first table, the value of the coefficient associated with each of the addresses in the first table so as to satisfy the continuity by updating a value of the coefficient associated with an update target address so as to become a value within a predetermined range from a value of the coefficient of the address that is adjacent to the update target address.

6. The distortion compensation device according to claim 4, wherein the first updating unit updates, regarding the coefficient associated with each of the addresses in the first table, the value of the coefficient associated with each of the addresses in the first table so as to satisfy the continuity by updating a value of the coefficient associated with an update target address so as to become a value within a predetermined range from an average value of the coefficients of two addresses that are adjacent to the update target address.

7. A distortion compensation method for compensating, by filtering an input signal that is input to a power amplifier, distortion of an output signal that is output from the power amplifier, the distortion compensation method performed by a distortion compensation device that includes
a first table that holds, among a coefficient of a linear term and a coefficient of a nonlinear term that are included in filtering coefficients used for filtering of the input signal, the coefficient of the nonlinear term associated with an address other than a prescribed address obtained from the input signal; and
a second table that holds the coefficient of the linear term related to the prescribed address, the distortion compensation method comprising:
calculating, based on the output signal, each of an update amount of the coefficient of the nonlinear term and an update amount of the coefficient of the linear term;
updating, based on the update amount of the coefficient of the nonlinear term, each of the coefficients in the first table; and
updating, based on the update amount of the coefficient of the linear term, each of the coefficients in the second table.
